(19) United States
(12) Patent Application Publication
(10) Pub. No.: US 2015/0186132 A1
(43) Pub. Date: Jul. 2, 2015

(54) USER INTERFACE FRAMEWORK AND TOOLS FOR RAPID DEVELOPMENT OF WEB APPLICATIONS

(71) Applicant: WOLTERS KLUWER UNITED STATES INC., NEW YORK, NY (US)

(72) Inventors: Anthony Oliveri, Greenlawn, NY (US); Piotr Dulak, Opole (PL); Sebastian Maleszewski, Wroclaw (PL); Adam Cuper, Katy Wroclawskie (PL); Pawel Majewski, Wroclaw (PL)

(73) Assignee: WOLTERS KLUWER UNITED STATES INC., NEW YORK, NY (US)

(21) Appl. No.: 14/145,848

(22) Filed: Dec. 31, 2013

(51) Int. Cl. G06F 9/44

(52) U.S. Cl. CPC G06F 8/70

(57) ABSTRACT

Web application development system with an associated user interface framework and a set of tools for the creation, configuration, management, and deployment of web applications that may be based on application templates and controlled by configurable runtime attributes. User interface framework contains packaged set of libraries for rapid creation of web applications, including template applications with configuration points called configurable runtime attributes. Tools contain a wizard-style application for selection of configurable runtime attributes and a web-based resource manager for selection of configurable runtime attributes, management of application packs including internationalization and skin packs, in-place editing of web application elements, and web application deployment.

### FIELD OF THE INVENTION

The present invention relates generally to web application development, and, more particularly, to a web application development system with an associated user interface (UI) framework and a set of tools for the creation, configuration, management, and deployment of web applications that may be based on application templates and controlled by configurable runtime attributes.

### BACKGROUND OF THE INVENTION

Web developers create conventional web applications by writing or editing HTML, CSS, JavaScript, PHP or other types of source code and markup languages before publishing the application on a web server.

Web application developers often rely on a web application framework to assist in the development of web applications. These frameworks speed development by providing libraries to perform activities commonly associated with dynamic web applications, and free an individual developer from the burdens of repeatedly implementing the same or similar tasks. Examples of web application frameworks include Microsoft's ASP.NET, JavaScript, JavaEE, WebObjects, Perl, PHP, Ruby on Rails, etc. Functionality provided by the libraries of these frameworks may include, for example, caching, database access, security, managing asynchronous HTTP requests, session management, or any other capabilities needed by a modern, dynamic web application. Conventional frameworks may be organized according to particular design principles intended to facilitate the development of web applications in a certain way such as Model-view-controller (MVC), three-tier (client, application, database), or “action based,” such as Ruby on Rails. The developer may create the application's user interface (UI) by relying on libraries and controls provided by the framework, or he may create his own custom controls. These web application frameworks require a developer to approach a project prepared to handle technologies such as HTML/HTML5, CSS, JavaScript, or other “source code-based” technologies to implement the application according to the framework's structure. It is unlikely a developer who is not proficient in the manual modification of these technologies could satisfactorily complete or modify a dynamic modern web application.

There are substantial drawbacks to using these conventional web application frameworks and development methods. The conventional development workflow often necessitates making many incremental edits to test how the changes affect the application. This usually entails editing one of the source files, such as, for example, a CSS file to alter the look and feel of the application, then publishing and reloading the application in a web browser to observe the result of the change. This approach can be problematic because of the trial-and-error nature of the process and because it can be unduly time-consuming.

Another drawback of conventional web application development is that there often exist dependencies between different areas of the web application wherein a change to one area might cause an unintended effect to another area that cannot be observed by the developer until he republishes and reloads the application. For example, altering language or internationalization settings may cause problems with another area of the web application, the layout, because text labels applied to the elements of the application may vary in length between different languages. For instance, a button with the English language label “average speed” might not be able to accommodate the same word in another language if the translation is a substantially longer word given the size constraints of the label, e.g., “Durchschnittsgeschwindigkeit” in German. In this instance, the web application's usability would suffer because the language change would render the button unreadable.

It can be difficult, and therefore time-consuming, even for a seasoned web developer, to locate the correct place in a source file to apply a desired change. For example, a web developer might quickly see in the page as it is rendered in his web browser where he would like to make a style change, but it may require a much longer time to locate the corresponding line in a CSS file and to determine an appropriate change. To do this effectively requires a deep knowledge of CSS structure. Even when the web developer does locate the correct location, the change might impact other areas as described above, thus forcing him to revert the change and wasting substantial effort. This dynamic means that even if a developer had a skeleton or template application that provided basic functionality, it would not be a trivial or straightforward task to adapt that application to a variety of segment-specific contexts, and, with conventional techniques, it could only be performed by a developer, rather than a user with less technical ability, such as a project manager, who may be in a better position to create the application from a business requirements perspective.

### SUMMARY OF THE INVENTION

The present techniques provide a UI framework having a suite of components, core libraries, documentation, and application reference templates, as well as tools that enable business product development teams, especially local teams, to quickly assemble, configure, and deploy customized web applications on an electronic content delivery and publishing platform or other content delivery network. The application templates of the invention enable the rapid development of configurable, segment-specific web applications by replicating reference applications with pre-selected configuration points controlled by configurable runtime attributes (CRAs). The tools include a web-based resource manager to allow users to select or modify skins, internationalization and language settings, and layout options in-place without manual modification of CSS, JavaScript or other program code, scripts, or markup languages. The web-based resource manager also includes an application pack manager (APM) that allows users to manage packs of resources that may be edited and saved to, or retrieved from, a remote repository. The web applications may be deployed on an electronic content delivery and publishing platform or any cloud-based platform.

As described in more detail below, the present UI frameworks, with a packaged set of libraries for web components, core web libraries, documentation, and application reference templates, may be built on top of existing web frameworks such as those referred to in the Background of the Invention section. UI frameworks may add improvements to these existing frameworks to ease quicker assembly of applications based on preexisting business requirements. Developing a web application with the UI framework supports two styles of web applications: a “one-off” application that may be expressly tailored to a specific purpose, and usually requires more custom code, or a template application that can be configured and replicated as described in detail below.

A template application is a web application that includes the framework together with custom controls, custom resources, and custom code. A template application may be built together with a custom Wizard-style application, which is used to select configurable runtime attributes (CRAs) and values for these CRAs in a step-by-step configuration process to control broad functionality of the templates that may be “switched” on or off. Examples of behavior set by CRAs include default language or layout options such as the number of columns in a search results pane. The custom Wizard application is also used by later developers who start with the template to create modified applications to suit their needs in a variety of contexts. This development model thus alters the behavior of these templates to leverage a general application design but retains flexibility by permitting changes to the CRAs for local or segment-specific customizations for different audiences

Before deploying the application, users such as developers or project managers can refine the application using a web-based resource manager tool. Primary capabilities of the resource manager tool are control over layout, skinning/styling/branding, languages/internationalization, layouts, and to control view templates. With the web-based resource manager, the edits to these resources may be maintained “in-place,” meaning they occur through the user interface so there can be an instant preview to see the impact of these changes on the UI (layout, size, width, etc). The user, therefore, is now able to work with language and skin resources, and create variants based on the existing application—conventionally “Web Designer” activity—but without making corresponding changes to CSS files. Using the resource manager, a developer can quickly replicate an application template to serve a variety of segment-specific purposes.

The web-based resource manager also has a web interface for configuring the combinations of elements supported by the underlying application template and setting the CRAs to create an application with customized user experiences. The interface allows for the export and import of all changed resources into a package, which may be stored remotely in a repository, so they may be moved between environments. The web resource packages may then be deployed to existing running applications deployed on an electronic content delivery and publishing platform or any cloud-based platform such as Microsoft Windows Azure Cloud Hosting.

### BRIEF DESCRIPTION OF THE DRAWINGS

For a more complete understanding of the disclosure, reference should be made to the following detailed description and accompanying drawing figures, in which like reference numerals identify like elements in the figures, and in which:

FIG. 1 is a flow chart illustrating a method of a high-level workflow for creating a web application in an example;

FIG. 2 illustrates an example architecture of a web application according to the UI framework;

FIG. 3 illustrates a UI framework module component architecture in an example;

FIG. 4 is a flow chart illustrating an exemplary for creating a web application template in an example;

FIG. 5 is a is a flow chart illustrating an exemplary method for selecting variations for an application template via the Wizard application by setting configurable runtime attributes;

FIG. 6 is a flow chart illustrating the workflow of a sample application created in an example;

FIGS. 7A-7D are screenshots of a custom step-by-step wizard application that illustrate the selection of configurable runtime attributes.

FIG. 8 illustrates capabilities of the web-based resource manager in an example;

FIG. 9 is an example screenshot of the web-based resource manager login screen;

FIG. 10 is an example screenshot of the web-based resource manager;

FIG. 11 is an example screenshot of the language pack manager capability of the web-based resource manager;

FIG. 12 is an example screenshot of the skin pack manager capability of the web-based resource manager;

FIG. 13 is an example screenshot of the application pack manager capability of the web-based resource manager;

FIG. 14 is another example screenshot of the application pack manager capability of the web-based resource manager;

FIGS. 15A-15D are flow charts illustrating various end-to-end work paths for creating, configuring, and deploying web applications in an example;

FIG. 16 is a flow chart illustrating two modes of web application development, “heavy” and “light,” in an example; and

FIG. 17 illustrates a cloud-based implementation of an application development and deployment platform.

While the disclosed methods and apparatuses are susceptible of embodiments in various forms, there are illustrated in the drawings (and will hereafter be described) specific embodiments of the invention, with the understanding that the disclosure is intended to be illustrative, and is not intended to limit the invention to the specific embodiments described and illustrated herein.

### DETAILED DESCRIPTION

Generally, techniques described herein provide a network-based web application development platform that provides a set of components and coding practices with tools to support development and speed the development life cycle. One of the tools is a web-based resource manager to enable easy customization of applications and easy adoption of applications based on templates across multiple segment-specific business units. The web-based resource manager supports live feedback via an application inspection tool and element information panes, in-place editing of language resources, style changes in the UI rather than in underlying CSS files, and import and export of resource bundles known as application packages. The application packages may contain CSS, language, and branding resources which can be grouped, inherited, and modified selectively to allow for easy reuse and customization of web applications, especially web applications based on application templates.

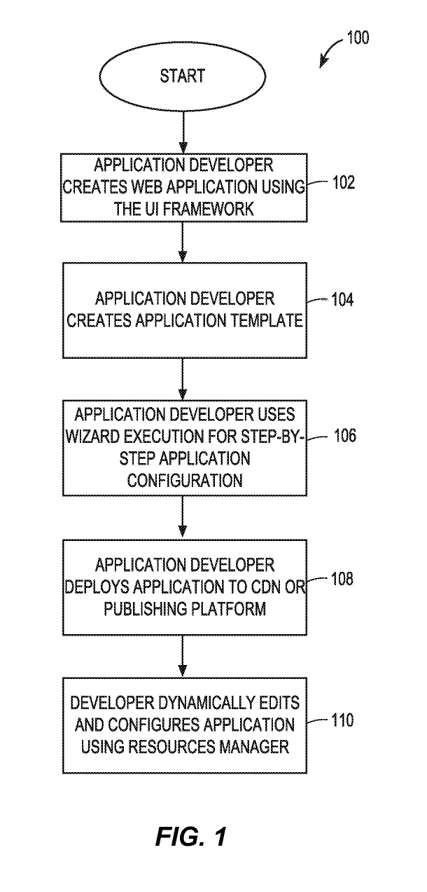

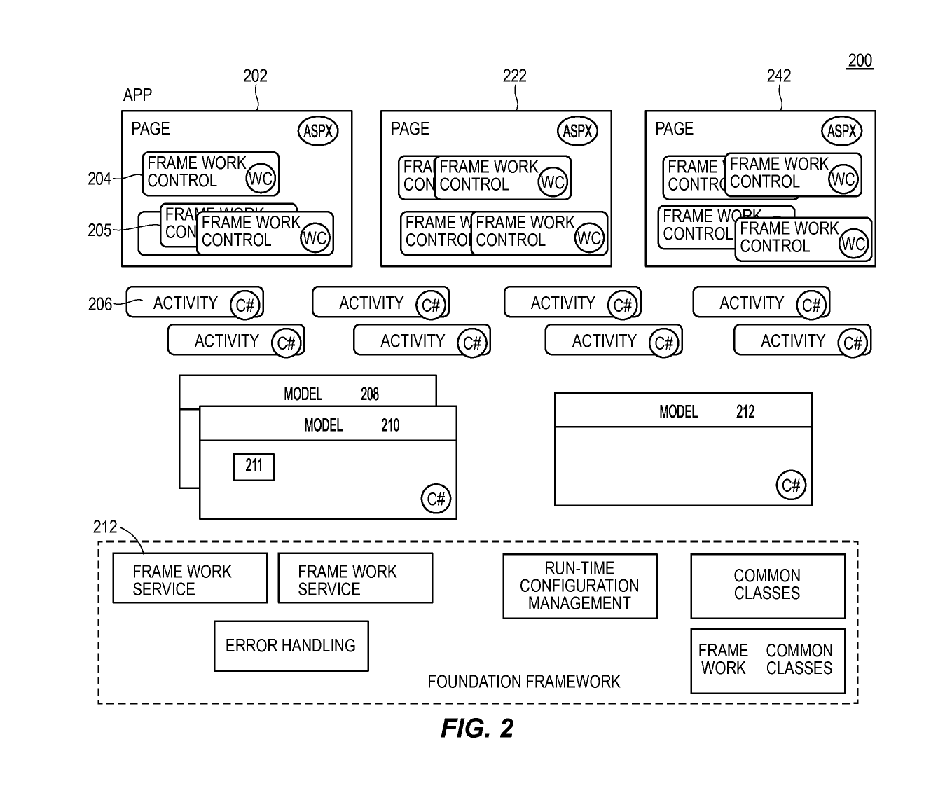

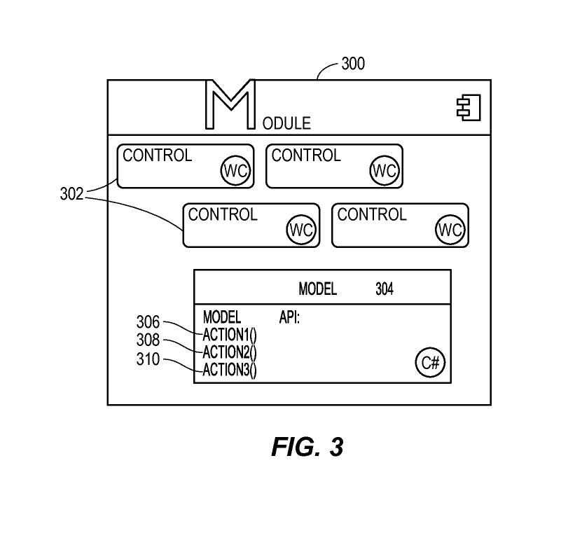

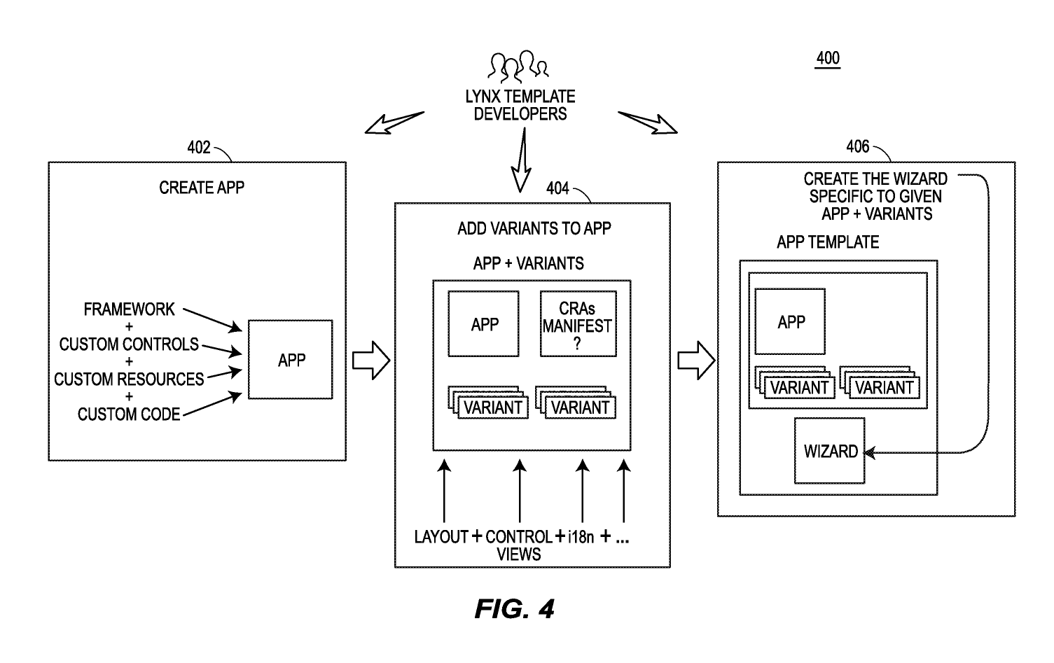

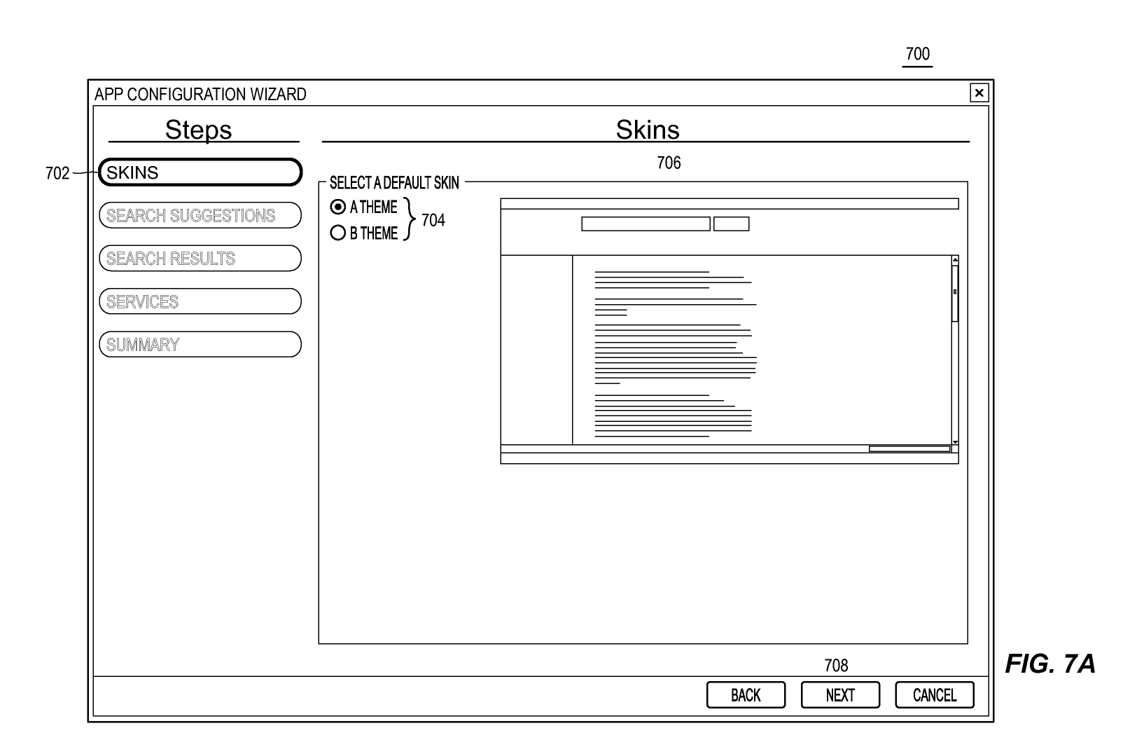

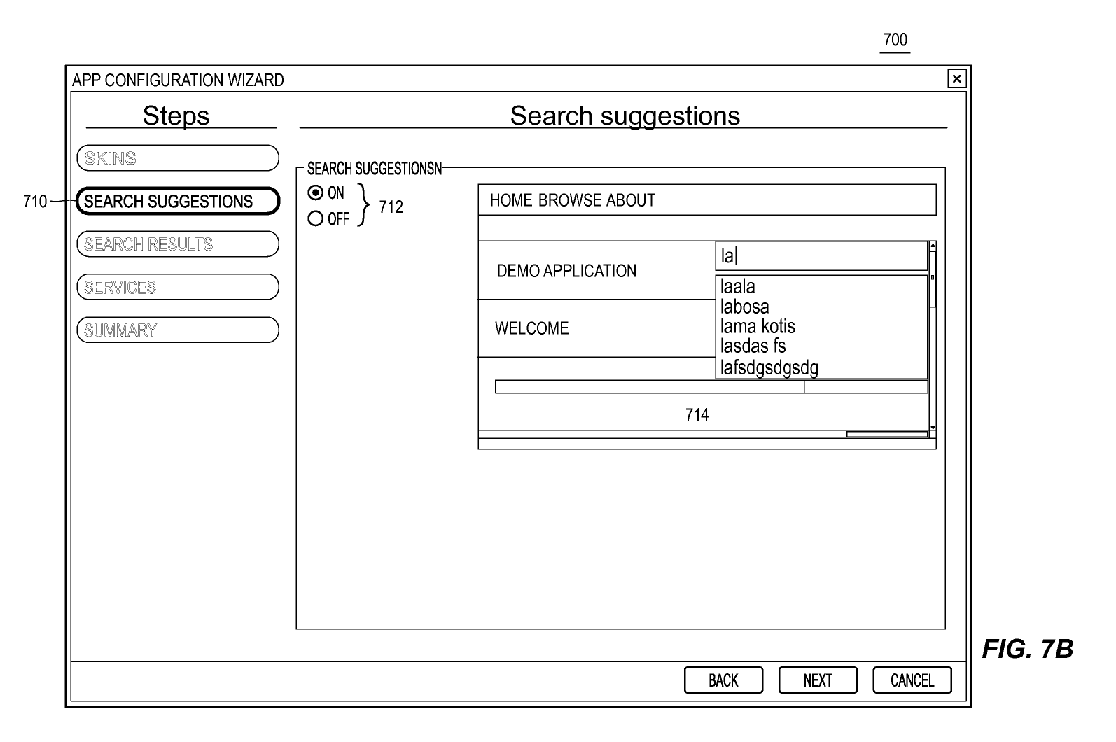

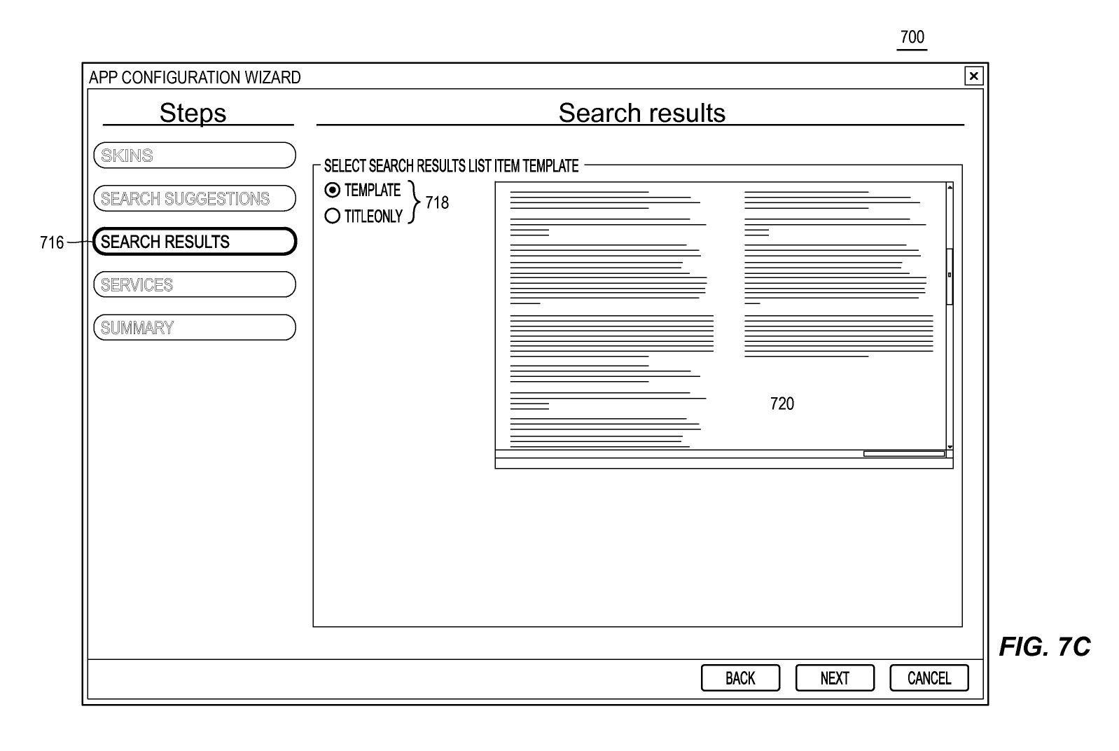

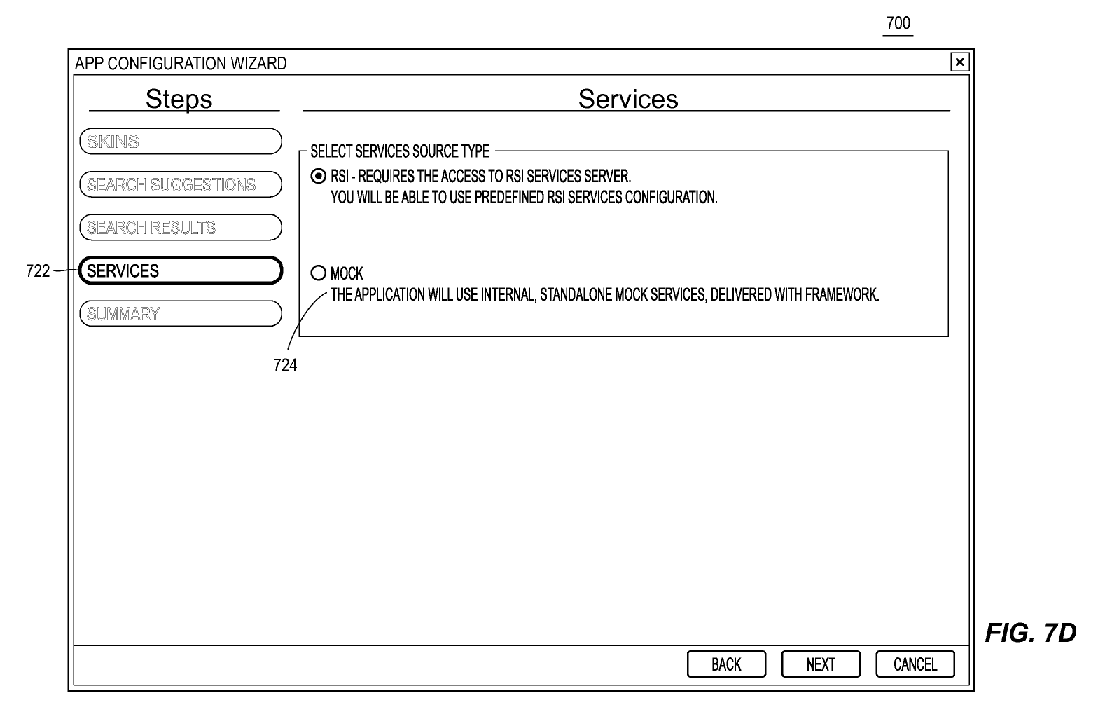

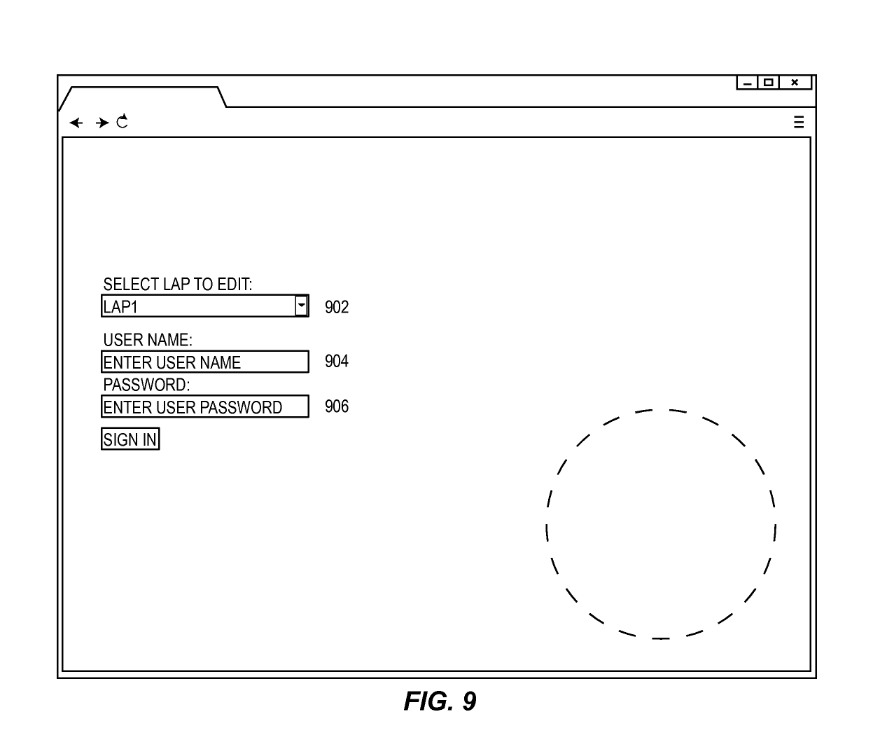

FIG. 1 is a flow chart illustrating a high-level workflow method 100 for creating a web application according to the invention. FIG. 1 illustrates an example end-to-end process of creating a web application in accordance an example. At Block 102, an application developer creates a web application using the UI framework as described below with reference to FIGS. 2 and 3. At Block 104, the developer may create an application template having several views and data sources bound together. A template would enable a later developer to select variations on the application to adjust and customize it for segment-specific purposes. For example, the size of a search results view, available search options, and internationalization or localization options may be adjusted. Adjusting these variants allows for a single template to be quickly adapted for a variety of similar uses, e.g., a legal research application, a medical research application, a tax research application, etc. Creation of an application template is described in more detail below in reference to FIG. 4. At Block 106, a developer may use the Wizard application to perform a step-by-step configuration on the application template by selecting and setting configurable runtime attributes as described in more detail below with reference to FIGS. 7A-7D. At Block 108, the developer deploys the application to an electronic content delivery and publishing platform. At Block 110, the developer may dynamically edit and configure the application via the in-place web resource manager, as described in more detail below with reference to FIGS. 9-15.

The UI framework may include a suite of components, templates, and tools that enable local business product development teams to quickly assemble and configure customized web applications which are deployed and run by connecting to an online content delivery and publishing platform. FIG. 2 illustrates example architecture of a web application 200 according to the UI framework. The framework used to create the application of FIG. 2 is shown, in this example, to be based on the Microsoft ASP.Net web framework; but one of ordinary skill in this art will recognize that the framework could be based on any similar web framework such as those referred to in the Background of the Invention section or other frameworks. Such an existing UI framework may be modified or extended to add improvements to the existing framework to ease quicker assembly of applications based on preexisting business requirements. The sample application of FIG. 2 illustrates a UI framework architecture having three web pages 202, 222, 242 implemented as ASPX pages because, in this example, the UI framework is based on ASP.Net. The framework may supply models such as models 208, 210, 212 with API functions with the ability to wire events associated with controls, custom or standard, in the ASPX pages such as search button 204 or controls 205. Framework supplied models may include, but are not limited to, a search model, document view model, and search results list model.

When creating a web application with the UI framework, the developer may introduce workflow changes, code changes, and develop view controls. The web application of FIG. 2 is structured as an application that accepts a search terms from a user via a search button, queries a backend data source using the search term, then displays the results. A user path through a web application configured in accordance with this example would begin with a user click on a control such as button 204, shown generically as a framework control in FIG. 2. Clicking this control causes the user's browser to perform an HTTP postback to target ASPX page 202. The UI control 204 in page 202 also triggers the execution of a framework event, illustrated in FIG. 2 as activity 206, implemented in C#. Activity 206 invokes a function 211 on the Model API 210, shown in FIG. 2 also as implemented in C#. Function 211 on Model API 210 connects with a backend framework service, database service 212. Framework database service 212 returns data, which is received and stored by Model API 210 function 211. Framework controls 205 in ASPX page 202 read the data from Model 210 API function 211 in rendering the HTML, which is sent back to the client browser and displayed in response to the HTTP postback as ASPX page 222.

The UI framework's component architecture may be based on modules such as module 300 illustrated in FIG. 3. A module contains one or more Controls 302 and a Model API 304 with functions such as Action Functions 306, 308, 310. As in the illustrations of FIG. 2, Module 300 is shown in FIG. 3 implemented in ASP.Net, but the modules may be implemented based on any web framework as disclosed herein. Example modules include a Document View module, a Search History module, a Research Folders module, and a Search module. Each module is associated with a set of controls to implement custom web application workflows according to a specific task that may be reused by different web applications implemented according to the UI framework. Exemplary controls include, but are not limited to, common controls, search module controls (search template control, search form control, search description control, advanced search control, search result list control, post search filter control), document view module controls, search form controls, results list controls, document view controls, generic list controls, branding logo controls, vertical menu controls, login controls, preview extender controls, horizontal menu controls, toolbar controls, multiview controls, suggestion extender controls, menu item controls, menu controls, frame controls, check box controls, button controls, toolbar controls, manager controls, or search module controls. Using modules facilitates tasks that may appear across a variety of web applications directed to different segments in the same field. For example, web applications directed to searching text references, may all employ the Search History module to display a history of previously executed searches made on a database of text articles or other materials. A Search History module may include controls that would be used in any such application such as a History List control, a History Menu control, and a Recent Actions control. In other examples, a Research Folders module may contain controls such as a List Folder Items control, a List View control, a Folder Note control, a Folders Combo box control, and a Folders Windows control. The Search module may contain a Search Form control, a Post Search Filter control, a Search Description control, and a Search Results List control.

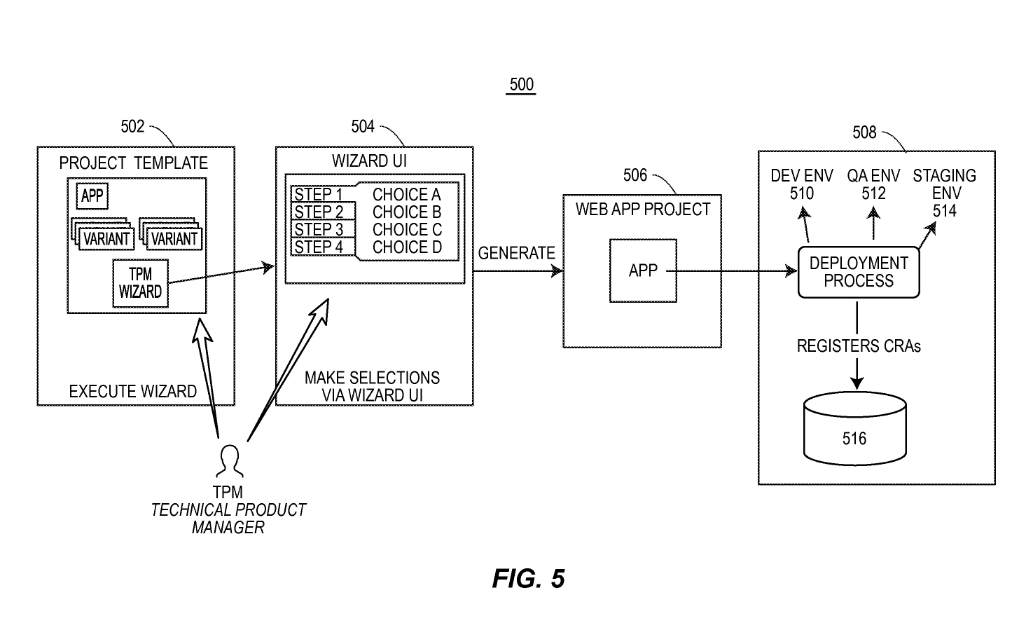

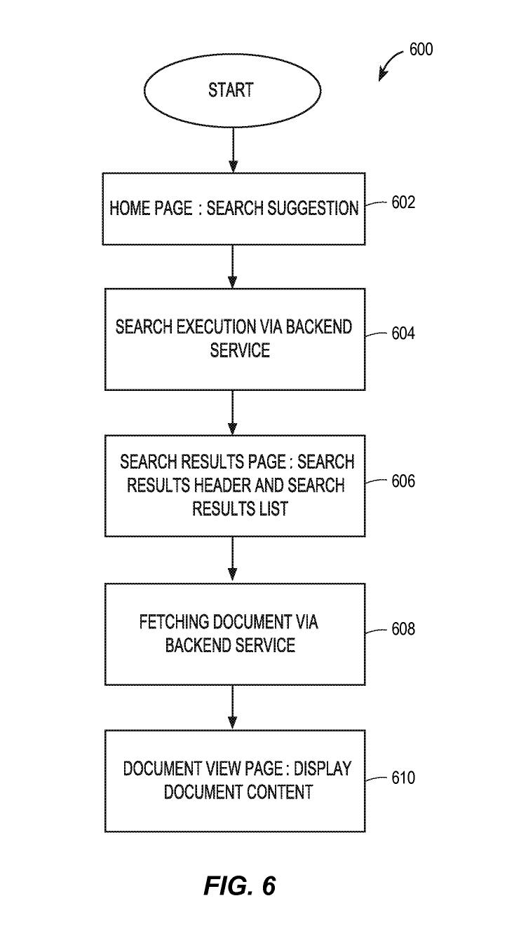

FIG. 4 illustrates an example process 400 for creating an application template in accordance with the invention. As discussed above, an application template is a UI framework-based web application with a “runtime configurability” property, i.e., the template contains all variants to be selected or configured by technical project managers or other users via the template's associated wizard application as described above with reference to FIG. 1. Runtime configurability allows users to leverage the similarities among the business needs of many different segments by using a single template with configurable runtime attributes that can be switched on or off (although they are not necessarily limited to two positions) to activate or configure functionality tailored to each of the business needs. With reference to FIG. 4, Block 402 shows the development of a web application in accordance with the invention as described in FIGS. 2 and 3 with the constituent components of the UI framework, any custom controls, custom resources such as the data back-end, and custom code to control layouts and views. Block 404 illustrates the selection of configurable runtime attributes, which are described in more detail below with reference to FIG. 5. As shown in Block 404, configurable runtime attributes may control variants such as, for example: application layout (e.g., whether search results are displayed in one column or two); control views, il8n internationalization (e.g., which language to apply to text on controls and other parts of the application); themes; whether a feature is enabled or disabled; whether a data source is available; etc. Block 406 illustrates creation of a step-by-step wizard application to facilitate the selection of the configurable runtime attributes selected in Block 404. Each application template has an associated wizard application that is built from a wizard application project provided as part of the UI framework. The wizard application project may be added to a web application project, such as web application 200. The wizard project allows for the addition of a custom step in the step-by-step process to set the value of a configurable runtime attribute. A custom step may be created by choosing a UI for the user screen that will display the step, adding custom information such as a preview image, associating the preview images with radio buttons, defining a wizard action when the configurable runtime attribute is selected by the user (i.e., set the value of the CRA selected or input by the user), and adding the new step to the existing wizard flow. The wizard application may be separately compiled as an executable, and is described in further detail below with reference to FIGS. 7A-7D, which show a screenshots of a completed wizard program for configuring the example application shown in FIG. 6.

FIG. 5 illustrates an example process 500 for selecting variations of an application template via the wizard application to set configurable runtime attributes. The wizard application is executed at Block 502 on a web application template created in accordance with the invention. Block 504 illustrates the multi-step nature of the Wizard selection process in Steps 1-4, each of which corresponds to a single configurable runtime attribute. Choices A-D are presented to the user as eligible values for the configurable runtime attribute associated with Step 1. Block 506 illustrates the completion of the wizard application, which results in the creation of a new web application based on the project template with the configurable runtime attribute values chosen by the technical project manager or user in Block 504. Block 508 illustrates deployment of the configured web application to development environment 510, quality assurance environment 512, or staging environment 514.

Block 508 also illustrates registration of the configurable runtime attributes with a product definition system 516. Product definition system 516 is a database repository of configurations of application products that may be used to create a hierarchy of configurations as bundles of configurable runtime attributes. The product definition system 516 thus acts as a collection of selectors of resources determined by the configurable runtime attributes. Product definition system 516 may be organized around a principle of inheritance to allow for the creation of applications by a base, template, or “root” application that define all common attributes. Additional attributes or modifications to the attributes may be made for applications configured based on the template or as child applications.

FIG. 6 is a flow chart illustrating a user path of an example application created in accordance with the invention. Although the sample application of FIG. 6 is designed to be a standalone application, it is created with configurable runtime attributes, which are configuration points that allow it to serve as an application template for future applications. Template users may replicate the application of FIG. 6 using the custom Wizard application to change the values of configurable runtime attributes, as shown in FIGS. 7A-7D. According to this example application, the developer first creates an HTML homepage with search input form control and search suggestion control provided by the UI framework. The developer next adds a Results List control to a Results web page and a Document View control to a Document web page. Then the developer binds the search input form control to the backend information store via an action function in a model supplied by the framework, and as described in more detail with reference to FIG. 2. Upon running an application configured in this manner, the user path is illustrated by the method 600 of flow chart of FIG. 6. The user would interact with this web application by making an HTTP request to the home page and entering the search term(s) at Block 602. The homepage search control is wired via the model action function to the backend data service, to which the control submits the search request at Block 604. The web application then responds to the user's postback HTTP request with the Search Results page 606 and fetches a document via backend service 608 before displaying document view page with document content in step 610.

FIGS. 7A-7D are screenshots of a custom wizard application 700 that illustrates the selection of configurable runtime attributes on the sample template application of FIG. 6. As described above configurable runtime attributes can configure variants of a web application to customize it for use in a particular segment. FIG. 7A illustrates a first step of the wizard application with Step 702 displayed to the user. Step 702 is directed to the configurable runtime attribute controlling the default web application skin, and the template contains two choices selectable by radio buttons 704. Each radio button, when selected, displays image preview 706 in a preview pane. Selecting Next button 708 records the user's choice and advances the screen to the next configurable runtime attribute. FIG. 7B is a screenshot of the wizard application showing Step 710. Step 710 is directed to the activation of an application feature, whether the search box will display search suggestions. This feature may be selected or de-selected using radio buttons 712. Preview pane 714 displays an image to illustrate the feature to the user, shown as activated in FIG. 7B. FIG. 7C is a screenshot of the wizard application on step 716. This configurable runtime attribute controls whether a search results item is displayed according to a UI framework template or with a title only. The selection is made using radio buttons 718. Preview pane 720 displays an image of the selected layout. FIG. 7D is a screen shot of the wizard application when step 722 is selected. This configurable runtime attribute controls the data source available to the search box in the sample application. Radio buttons 724 control whether the application is “live” or connected to a demonstration database.

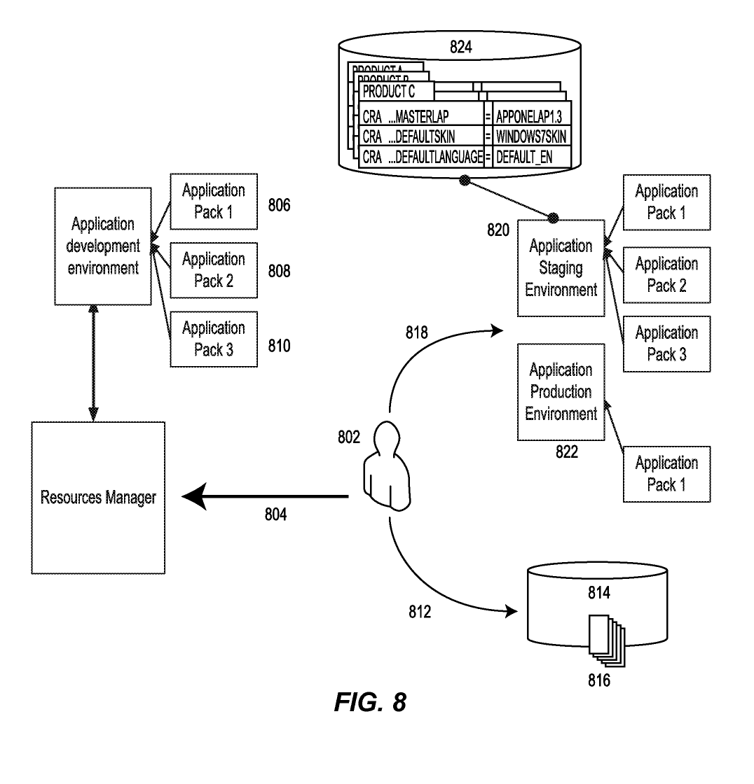

FIG. 8 illustrates a web application deployment process and the capabilities of the web-based resource manager. FIG. 8 illustrates the relationship between technical project manager 802, or any other similar user, and the configuration and management of a web application with configurable runtime attributes using application packs. An application pack is a consistent set of resources including one or more of skins, internationalization resources (also known as i18n resources), and view templates. At step 804, the technical project manager uses the web-based resource manager to configure a web application. The web-based resource manager has several key features allowing for the in-place editing and configuration of a deployed application that are described in more detail in the screenshots of FIGS. 9-15. The technical project manager may rely on application packs associated with the web application such as application packs 806, 808, 810 to access resources such as images, layouts, fonts, internationalization data, etc. Technical project manager 802 may also use the web-based resource manager to edit application packs to, for example, perform in-place edits to the resources contained in the application packs, including the addition of new resources. Once edited, these application packs may be stored and organized by importing from or exporting to a remote or local repository such as database 814 in step 812. Database 814 stores edited application packs 816, and may be any type of database or source code control tool such as, but not limited to, CVS, Microsoft Team Foundation Server, or any type of native file system. An application pack is deployed to the application at step 818, which may be either to a staging environment 820 or to a production environment 822. Such deployed web applications contain configurable runtime attributes to control: the master selector of which application pack version to be used by the application; skin selection; language selection; and view templates selection. These configurable runtime attributes are shown in data store 824 as name/value pairs for an application titled Product C. Variations on these configurable runtime attributes may be stored for other web applications in data store 824.

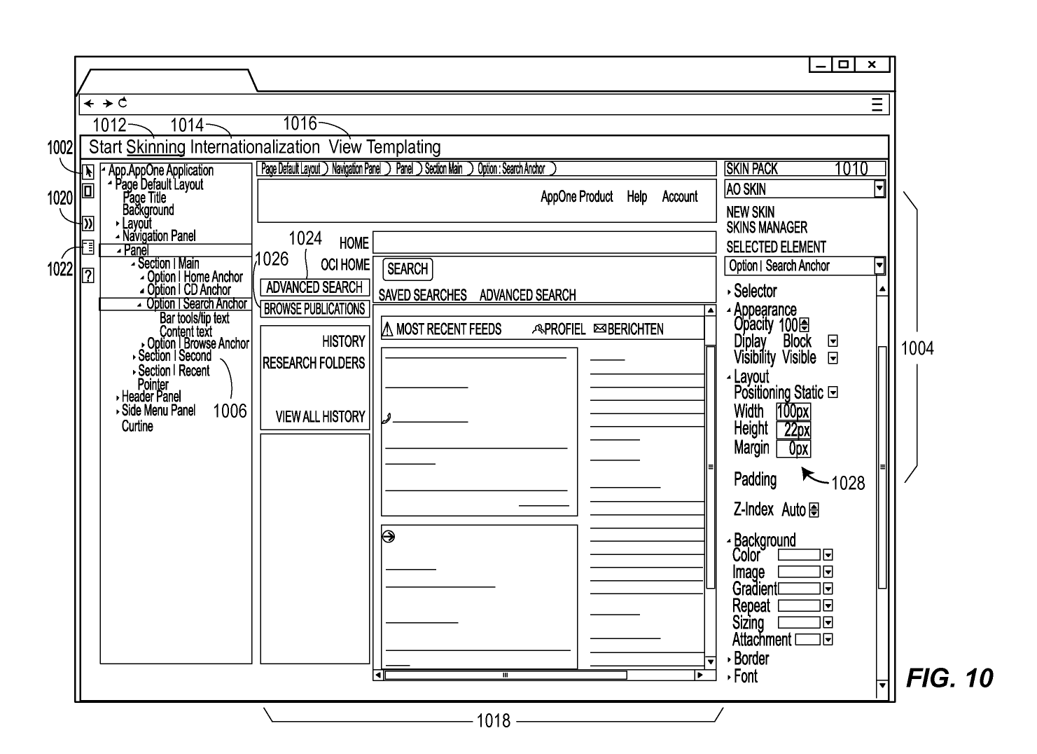

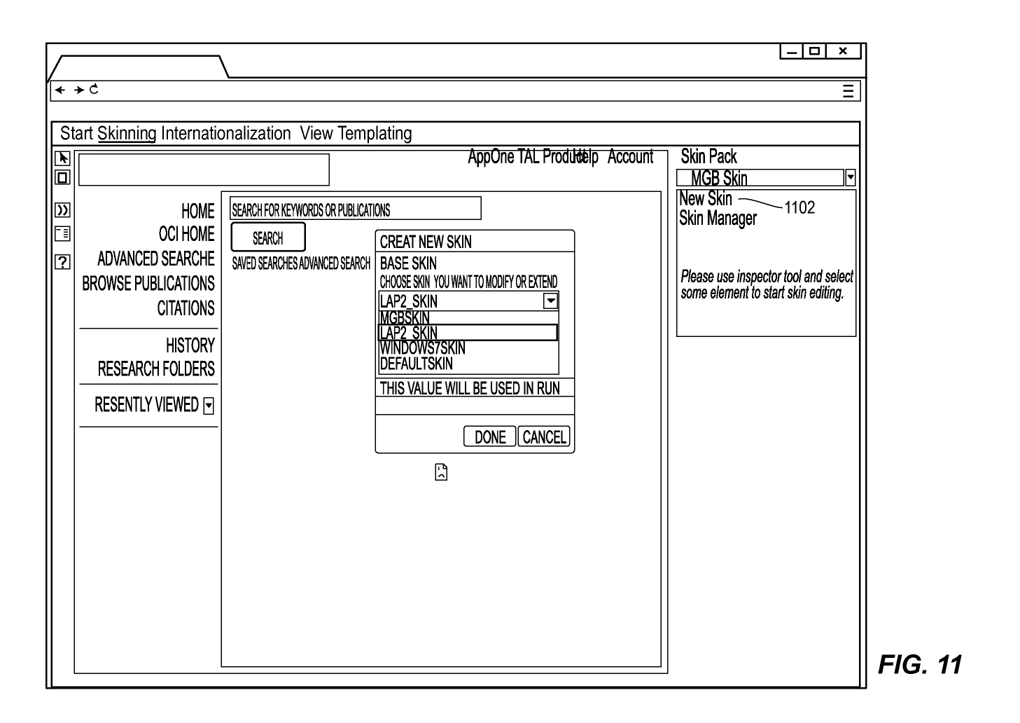

FIG. 9 is a screenshot of the login screen of the web-based resource manager. The screen contains a drop-down box 902 to select the application pack for editing, as described above with reference to FIG. 8, as well as user name text entry box 904 and password text entry box 906. FIG. 10 is a screenshot of the web-based resource manager after login. The web-based resource manager has several key features including: an inspection tool 1002, an element property viewing and editing pane 1004, framework element views including a tree view 1006 and path view 1008, and skin manager 1010 and internationalization manager (shown in FIG. 11) for retrieving and editing skins and internationalizations, respectively. Tree view 1006 is shown or hidden from the web-based resource manager UI via toggle button 1022. Similarly, path view 1008 is shown or hidden from the web-based resource manager UI via toggle button 1020. Skin manager 1010 is displayed by clicking on Skinning navigation button 1012. Similarly, Internationalization navigation button 1014 and View Templating navigation button 1016 display their respective manager windows to the right of web application display window 1018. The web-based resource manager covers three main functional areas: (1) in-place customization of a web application UI's look and feel through dynamic CSS property editing, including branding and graphics; (2) in-place editing of internationalization/UI text strings, i.e., the editing of text resources; and (3) in-place control view templating, which is the editing of controls' template source code such as ASP or HTML. The web-based resource manager is, in one respect, the enabling aspect of the web application development system disclosed herein because a technical project manager, when dealing with a deployed web application, uses the web-based resource manager to edit application packs, and store the resulting resources, such as in a compressed file, so that the resources contained therein are available to web applications that request them based on their configurable runtime attributes. The web-based resource manager provides this functionality even through the user may not necessarily be a user with the capability of editing source code, which would conventionally be required to perform this type of task.

FIG. 10 illustrates the in-place editing capability of the web-based resource manager. The in-place editing is accomplished primarily through the use of inspection tool, available at button 1002. When the user clicks button 1002, the inspection tool is activated, and any subsequent click on any element in the page causes that element's property data to be displayed in editing pane 1004. In the example of FIG. 10, the user has selected button 1024 titled Advanced Search. The selection of Advanced Search button 1024 is indicated by border highlighting box 1026. When any page element has been so selected, the element's properties are displayed in editing pane 1004 such that the user may alter those properties in-place by typing new values in any field, such as, for example pixel margin field 1028. The web-based resource manager responds to any changes in element property fields by altering the corresponding CSS or other corresponding resource file to reflect the change. Because the web-based resource manager displays the interface in a web browser, this change is immediately reflected in the display rendered by the browser.

The inspection tool may also be used in conjunction with two information panels, path view 1008 and tree view 1006, available via buttons 1022 and 1020, respectively. These information panels provide hierarchical information regarding the location in the page of the currently selected page element. For example, FIG. 10 illustrates an Option Search Anchor element 1024 as selected by the inspection tool. Tree view 1006 shows the location of this element in relation to the other elements on the page. Similarly, path view 1008 shows the location of the selected element in relation to the elements above it, up to the root element on the page, in this example, the Page Default vLayout element. When editing the properties of an element, the editing pane 1004 may display any number of properties used to describe the element with respect to its size, position, orientation, opacity, color, font, association with other elements or relation to other elements, image, shading, texturing, visibility, background, border, layout, or appearance.

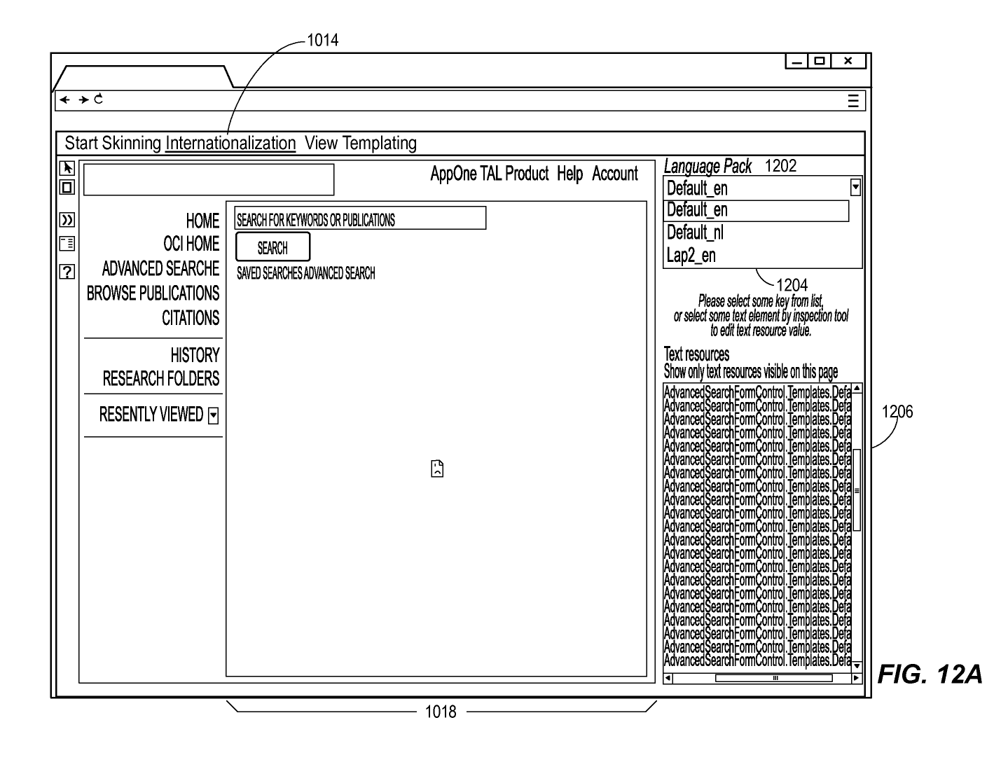

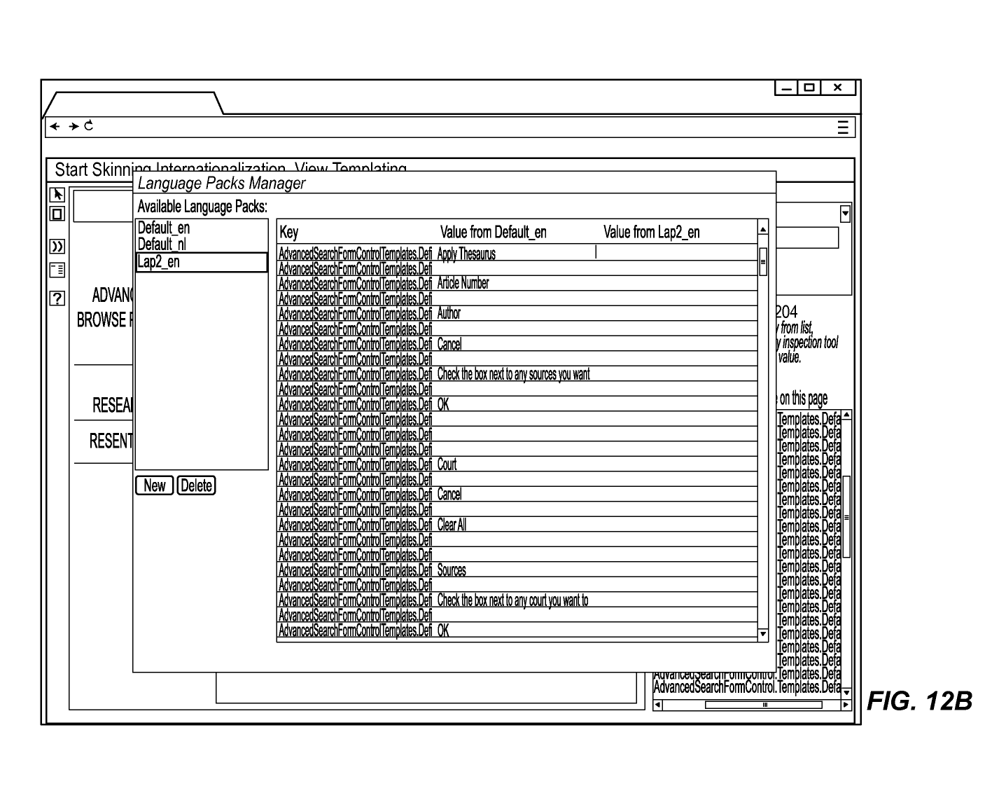

FIG. 11 is a screen shot of the functionality associated with New Skin button 1102. New Skin button 1102 allows a user to create a new skin based on a previously saved skin pack. FIG. 12A illustrates internationalization manager 1202, which is accessed via Internationalization button 1014. The internationalization manager contains drop-down box 1204 for the selection of languages associated with the current application pack. Each language displays associated text resources for each control in Text Edit window 1206, that may be edited in-place by the user. When a user makes an edit to a text resource, the web-based resource manager updates the corresponding CSS file to display the edited text on the element in the Application Display window 1018.

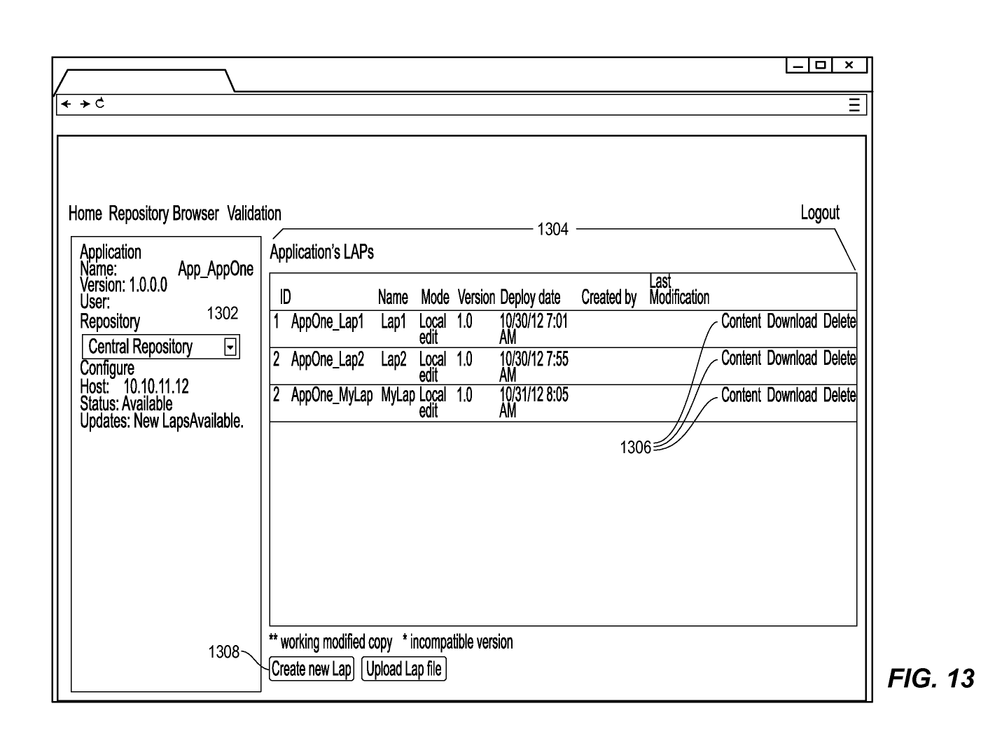

FIGS. 12A and 12B are screenshots of the internationalization manager of the web-based resource manager. Drop-down box 1202 is accessed via Internationalization button 1014, and displays a list of available internationalization packages 1204. Display and editing pane 1206 displays sets of name/value pairs corresponding to the web page element text fields and their values under the skin pack selected in window 1202, i.e., the text that will be displayed in web application viewing window 1018. FIG. 12B is a screenshot of another embodiment of the internationalization manager wherein the name/value pairs are accessible from the application pack manager (APM) disclosed in FIG. 13.

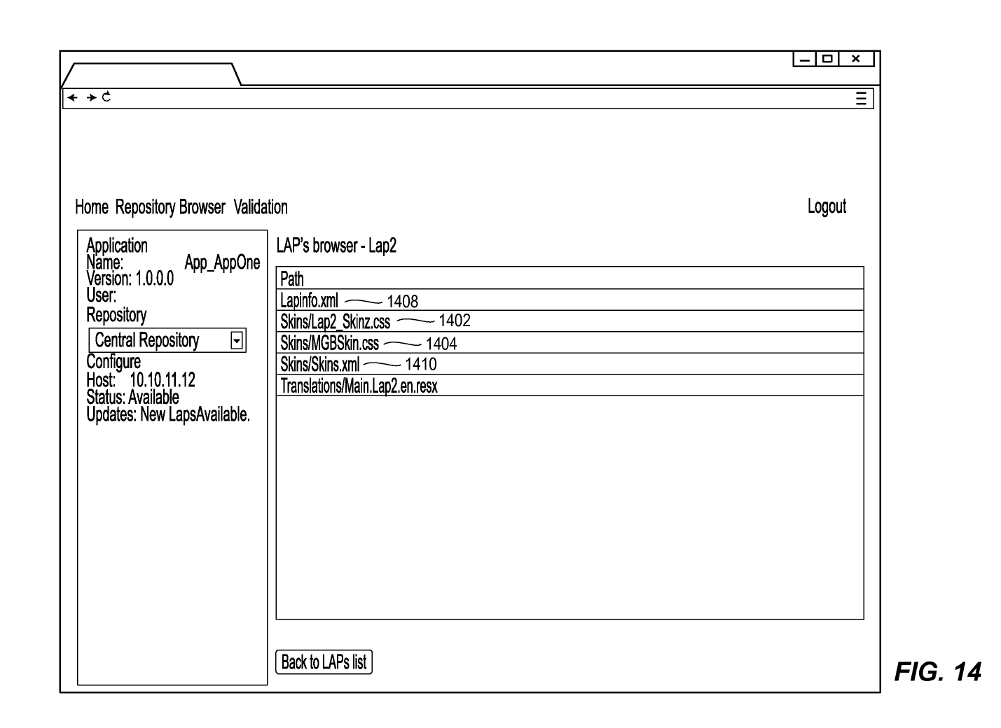

FIG. 13 is a screenshot of the application pack manager (APM) capability of the web-based resource manager. The APM is a packager of packs that may be edited in a web-based resource manager session. The APM may be used to save application packs and deploy them to the running environments of application instances. The APM makes available the ability to edit application packages and to store the edited packages as new packages, then deploying them to a location where configurable runtime attributes may access them to set the functionality of the invention's web applications. The APM may be used to store application packs in one or more remote repositories as described above in reference to FIG. 8. These repositories may be selected via Repository drop-down box 1302. Available application packs are displayed in Application Pack window 1304. Content buttons 1306 make available the constituent parts of an application pack as shown with reference to FIG. 14. Create New Pack button 1308 allows for the creation of a new application pack, which may be based on an existing application pack.

FIG. 14 is a screenshot of the application pack browser capability of the web-based resource manager. This capability is accessed via the Content button 1306 in the APM. In an example, the selected application pack contains CSS files 1402, 1404 corresponding to available skins, and resx file 1406 corresponding to language settings. Another part of the application pack is XML information file 1408 containing meta information regarding the application pack, including creation date, creator ID, description, default status, name, version, and mode. The application pack may further contain skin XML information file 1410 containing information such as the ID and path information of available skins in the application pack.

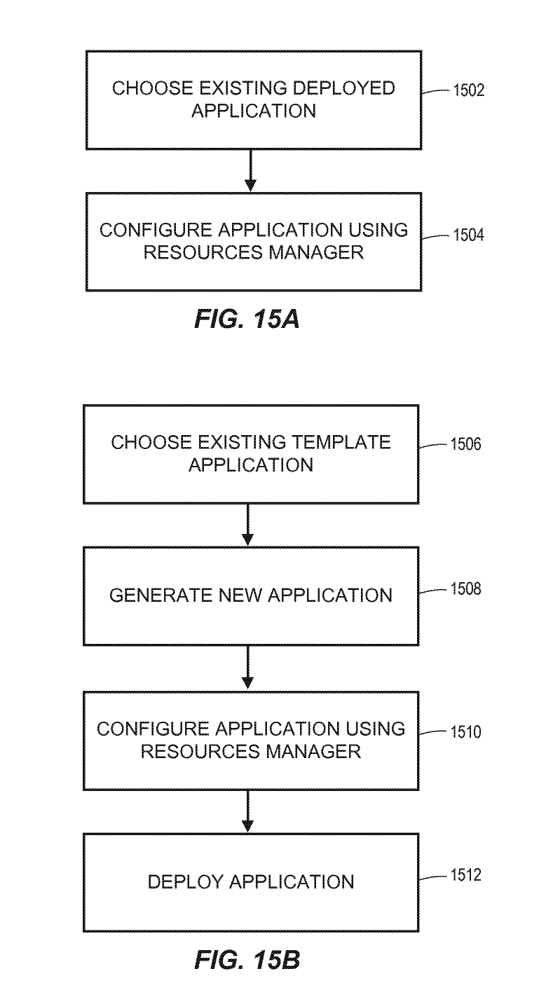

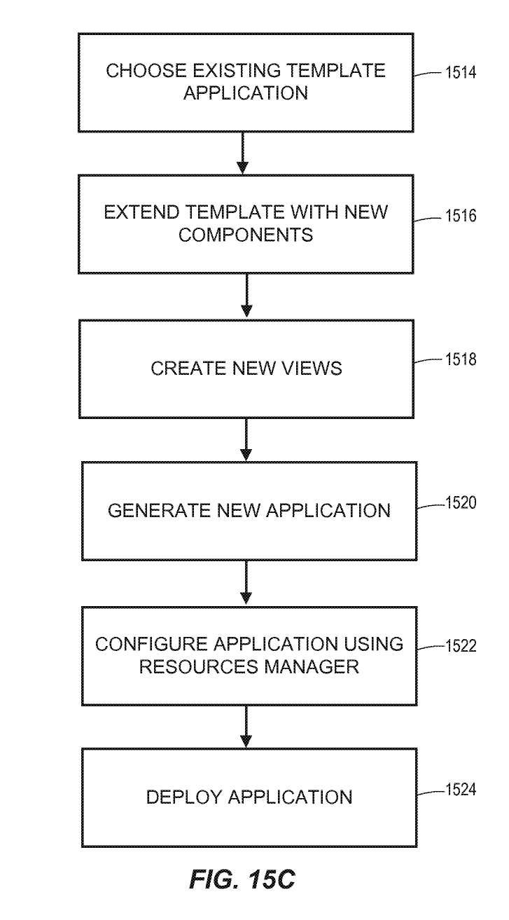

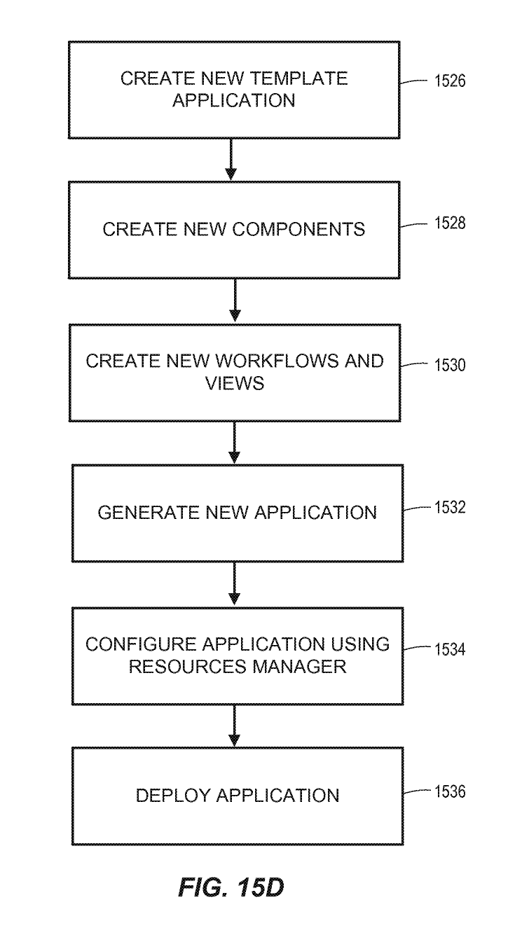

FIGS. 15A-15D are flow charts illustrating different work paths for creating, configuring, and deploying web applications in accordance with the invention. These workflows for creating a new web application in accordance with the invention range from very fast and easy to complex, and may be scaled to the size of the resources intended to be devoted to any particular application. FIG. 15A is a block diagram illustrating the shortest, quickest development process wherein an existing deployed application is re-configured to meet additional business requirements. In this workflow, a developer chooses an existing deployed application at Block 1502. At Block 1504, the developer configures and deploys the application in accordance with business requirements using the web-based resource manager. An alternative, slightly more complex workflow, is illustrated by the block diagram of FIG. 15B, wherein the UI is based entirely on an existing template with no additional functional components. The candidate application would need to be highly similar to the target application, with needed modifications only to skins, layout, or internationalization settings. At Block 1508, the developer generates a new web application based on the template of the existing application. At Block 1510, the developer configures the template using the web-based resource manager, and deploys the application at Block 1512.

FIG. 15C is a block diagram illustrating an example workflow wherein a developer chooses an existing template application at Block 1514. The workflow of FIG. 15C is appropriate where a template exists that contains a user interface similar to the user interface of the target development application. The developer extends the template at Block 1516 by adding new components. The developer then creates new views at Block 1518 to generate a new application at Block 1520. Finally, the developer uses the web-based resource manager to configure the application in Block 1522 and deploys the application in Block 1524. FIG. 15D is a block diagram illustrating a further workflow for creation of a web application in accordance with the invention. The workflow of FIG. 15D envisions a product with a wholly differentiated user interface. It begins, therefore, at Block 1526 with the creation of a new application template. The developer extends the template at Block 1528 by adding new components. The developer then creates new views at Block 1530 to generate a new application at Block 1532. Finally, the developer uses the web-based resource manager to configure the application in Block 1534 and deploys the application in Block 1536. FIG. 15D is a block diagram illustrating a further workflow for creation of a web application in accordance with the invention.

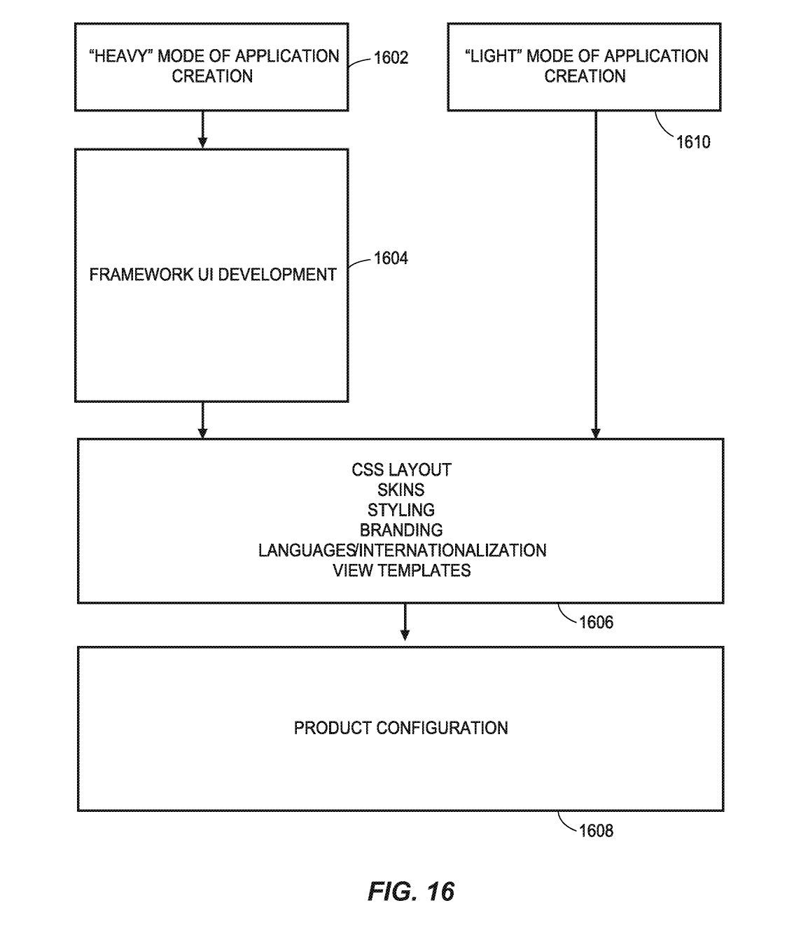

FIG. 16 is a flow chart illustrating two modes of web application development in accordance some examples. On one hand, a “heavy” mode of web application development is depicted starting with Block 1602. In Block 1604, a web application developer creates the web application by performing tasks such as coding in a language such as C#/ASPX/PHP/etc., creates application structure and logic changes, creates custom web controls, creates component instantiation and orchestration, makes workflow designs, makes logic changes, binds the application with configurable runtime attributes, and implements a master layout of the inventory of web pages and designation of logical blocks on each page. The web developer uses tools including a source code editor such as Microsoft Visual Studio or other development tools for “heavy coding.” At Block 1606, a web designer performs tasks such as light layout adjustments through CSS-driven placement of elements on a web page, selection of languages and internationalization options for the page, and view templates for controls. The web designer uses tools including a source code editor such as Microsoft Visual Studio, browser plug-ins for layout inspection and adjustment such as Mozilla Firebug, and CSS editors. This work requires low level knowledge about the application, and involves going through many cycles of incremental change, application restarts, and page refreshes in a web browser. A drawback of this approach is that application pages can be displayed in many states, and a single cycle from a code change to getting the expected user interface state of the application might require many clicks and significant amount of time. At Block 1608, a technical project manager configures the application to create an application instance by selecting available variants using configurable runtime attributes.

FIG. 16 also illustrates another approach, termed the “light” mode of application development. In this mode, starting at Block 1610, a developer begins with an existing application template and proceeds to Block 1606. The invention is especially adapted to the “light” mode of application creation to the extent the web-based resource manager is used to carry out the tasks for the web designer in Block 1606. The web-based resource manager's live feedback, visual discovery of what can be customized, in-place editing of language resources, in-place style changes directly to the user interface (not in CSS), in-place editing of view templates, and import or export of resources eliminate the typical drawbacks of the web designer activities and becomes the primary tool for the tasks of Block 1606.

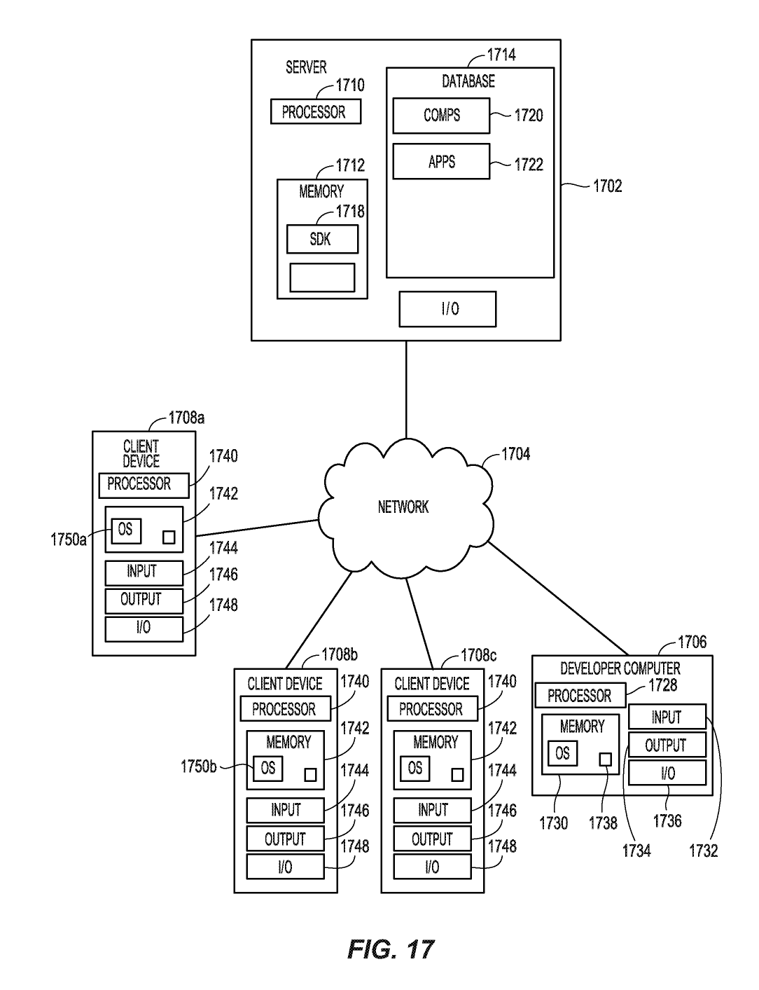

FIG. 17 illustrates a cloud-based implementation or other distributed computing environment of an application development and deployment platform in accordance with an embodiment of the invention. The cloud computing environment 1700 includes one or more servers 1702 communicatively coupled via a network 1704, such as the Internet, to one of a plurality of web application developer computing devices 1706, which may be used by the web application developers, for example, and to a plurality of client devices 1708a-1708c. While FIG. 17 depicts only a single server 1702, it will be appreciated that any number of servers 1702 may be part of the cloud computing environment 1700, and that the number of servers 1702 participating in the cloud computing environment 1700 need not be constant.

Additionally, while one developer computing device 1706 and three client devices 1708a-1708c are depicted in FIG. 17, any number of computing devices and any number of client devices may be communicatively coupled to the server(s) 1702 via the network 1704, as is generally understood with respect to Internet cloud computing systems operating in accordance with the Software-as-a-Service (Saas) model. Further, each of the developer computing devices 1706 and the client devices 1708a-1708c may be coupled to the network 1704 via wired or wireless communication channels including, by way of example and not limitation, wired Ethernet connections, IEEE 802.11 wireless protocols (“Wi-Fi”), wireless telephony links, and the like.

The server 1702 includes a processor 1710, a memory device 1712, and a database 1714. As is generally understood, the processor 1710 is communicatively coupled to the memory device 1712 and the database 1714, and operates to execute machine-readable instructions stored on the memory device 1712. As used herein, the phrase “machine-readable instructions” indicates compiled (or compilable) instructions, scripting languages (e.g., JavaScript), or any other set of instructions operable to cause a processor to perform one or more operations. In some embodiments, the instructions are parsed by an interpreter and the interpreter causes the processor to perform the operations. The machine-readable instructions stored on the memory device 1712 of the server 1702 include at least a server module 1716 and a software development module (or software development kit—“SDK”) 1718. Of course, other routines and/or modules, such as operating systems, device drivers, and the like, may also reside on the memory device 1712. In some embodiments, such as that just described, the processor 1710 is a general purpose processor programmed by the machine-readable instructions stored on the memory device 1712 to perform as a special-purpose processor. In other embodiments, however, the processor 1710 may be a special purpose processor designed to perform the tasks specified by the computer-readable instructions. Where the processor 1710 is a special purpose processor, the processor 1710 may be permanently configured according to the computer-readable instructions (e.g., an application specific IC (ASIC)), may be semi-permanently configured according to the instructions (e.g., a field programmable gate array (FPGA)), etc.

In any event, the processor 1710 may operate, according to the computer readable instructions, on data stored in the database 1714. The data stored in the database 1714 may include any type of data, but in at least one embodiment, the database 1714 stores at least data for implementing and using the software development kit 1718. For example, and as described in detail above, the database 1714 may store a set of components 1720 (such as the UI framework) for use by a developer using the software development kit 1718 to create one or more web applications. The components 1720 include, in embodiments, the part of the UI framework described above. The database 1714 may also store applications 1722 as described above. The applications 1722 may be stand-alone applications or template applications.

Each of the developer computing devices 1706 includes a processor 1728, a memory sub-system 1730 (including volatile and non-volatile memory), one or more input devices 1732, one or more output devices 1734, and an input/output subsystem 1736 for communicating with other devices (e.g., with the server 1702 via the network 1704). As should be understood, the processor 1728 operates to execute machine-readable instructions stored in the memory subsystem 1730. The machine-readable instructions may include a routine 1738 for accessing, via the network 1704, the software development module 1718 operating on the server 1702. The routine 1738 may, in an embodiment, be a web browser. In another embodiment, the routine 1738 may be an application dedicated to accessing the software development module 1718. The machine-readable instructions may further include other routines or modules (e.g., an operating system, other software applications, etc.). The input device 1732 and output device 1734 may be any known or future input and output devices. For example, the input device 1732 may be a keyboard, a pointing device (e.g., a mouse or trackpad), a touch-sensitive display, a microphone, etc. Likewise, the output device 1734 may include a display device.

Similarly, each of the client devices 1708a-1708c includes a processor 1740, a memory sub-system 1742 (including volatile and non-volatile memory), one or more input devices 1744, one or more output devices 1746, and an input/output subsystem 1748 for communicating with the other devices (e.g., with the server 1702 via the network 1704). The processor 1740 operates to execute machine-readable instructions stored in the memory subsystem 1742.

The machine-readable instructions stored in the memory subsystem 1742 of each of the client devices 1708a-1708c may include an operating system and one or more other software applications. The operating system on each of the devices 1708a-1708c need not be identical. In the client device 1708a, for example, the memory subsystem 1742 is depicted as including a first operating system 1750a, while in the client devices 1708b, for example, the memory subsystem 1742 is depicted as including a second operating system 1750b. That is, client devices using different operating system may mutually communicate with the server 1702 via the network 1704 to access applications (e.g., applications 1722) created by developers using the software development module 1718. The client device 1708a, for example, executing the operating system 1750a, while the client devices 1708b and 1708c may access a second one of the applications 1722.

What is claimed is:

1. A computer-implemented website application resource management system comprising:
a memory;
an element inspection tool;
an element attribute display and editing module;
a website application display module;
a skin pack module;
wherein the website application viewing module is configured to present a website application containing one or more user interface elements;
wherein the element inspection tool is configured to receive user input to select one of the one or more user interface elements displayed by the application display module;
wherein the element attribute display and editing module is configured to retrieve from the memory and display one or more attributes and corresponding attribute values associated with said user-selected component;
wherein the element attribute values determine the manner in which the corresponding components are to be displayed by the website application viewing module;
wherein the element attribute display and editing module is further configured to receive user input to alter one or more attribute values associated with said selected element;
wherein the website application display module is further configured to present the user-selected element according to the one or more user-altered attributes; and
wherein the skin pack module is configured to store a collection of attribute values in the memory corresponding to elements displayed in the website application display module.

2. The system of claim 1 wherein the skin pack module is further configured to retrieve a previously stored skin pack and apply the previously stored skin pack's component attribute values to the website application displayed in the application viewing module.

3. The system of claim 1 further comprising:
an element path panel to display the hierarchical location of a selected component.

4. The system of claim 1 further comprising:
a toggle switch to highlight elements selected using the component inspection tool.

5. The system of claim 1 further comprising:
a switch to display an element tree panel.

6. The system of claim 1 further comprising:
wherein the website application viewing module is configured to indicate the currently selected component by rendering a border around said component.

7. The system of claim 1 further comprising:
an option to select the display of tooltips.

8. The system of claim 1 further comprising:
an application resource bundle manager panel.

9. The system of claim 1 further comprising:
a toggle switch to highlight components selected using the inspection tool.

10. The system of claim 1, wherein the highlighting comprises rendering a border around the selected component.

11. The system of claim 1 further comprising a bar to select from among Start, Skinning, Internationalization, and View Templating.

12. The system of claim 1, wherein the element tree panel comprises collapsible nodes.

13. The system of claim 1, wherein the component attributes displayed in the component attribute panel comprise one or more of:
selector, appearance, layout, background, border, font, paragraph, or other.

14. A browser interface for website application package management, wherein the browser interface includes:
a component text attribute panel;
a website application viewing panel;
a language pack manager;
wherein the component text attribute panel displays a list of one or more components in the website application;
wherein the component text attribute panel is adapted to receive input from a user to select a component in the website application;
wherein the component text attribute panel displays the text associated with the selected component and is adapted to receive new text from a user;
wherein the language pack manager is adapted to store a currently displayed set of component attributes as a language pack.

15. A browser interface for website application package management, wherein the browser interface includes:
a component text attribute panel;
a website application viewing panel;
a language pack manager;
wherein the language pack manager is adapted to receive input from a user to select a stored language pack; and
wherein the language pack manager applies the selected language pack to the components in the website application.

16. A method for managing website application packages, the method including:
receiving user input to select a component displayed in an application viewing panel;
displaying attributes of said selected component in a component attribute panel;
receiving user input to alter one or more attributes of said selected component;
storing a set of attributes for one or more components as a skin pack.

17. A method for configuring website applications based on templates, the method including:
selecting an website application template with configurable runtime attributes;
choosing values for said configurable runtime attributes to configure the website application;
deploying said configured web site application to an electronic content delivery platform.
